(19) United States
(12) Patent Application Publication
(10) Pub. No.: US 2014/0347261 A1
(43) Pub. Date: Nov. 27, 2014

(54) ARRAY SUBSTRATE AND LIQUID CRYSTAL PANEL

(71) Applicant: Shenzhen China Star Optoelectronics Technology Co., Ltd., Shenzhen, Guangdong (CN)

(72) Inventors: Jingfeng Xue, Shenzhen City (CN); Je-hao Hsu, Shenzhen City (CN)

(21) Appl. No.: 13/985,661

(22) PCT Filed: Jun. 27, 2013
(86) PCT No.: PCT/CN2013/078205

§ 371 Date: Aug. 15, 2013

(30) Foreign Application Priority Data
May 24, 2013 (CN) 2013101985275

(51) Int. Cl. G09G 3/36

(52) U.S. Cl. CPC G09G 3/3622
USPC 345/92; 345/87

(57) ABSTRACT

An array substrate and a liquid crystal panel are disclosed. The first scanning line is configured to turn on or off the first switch and the second switch. The data line connects to the first pixel electrode and the second pixel electrode respectively by a first switch and a second switch. The second scanning line is configured to turn on or off the third switch. The input end of the third switch connects to one of the pixel electrode. The output end of the third switch and the common electrodes are connected. With the above configuration, the aperture rate in the 2D display mode is enhanced and the cross talk in 3D display mode is reduced. In addition, the number of the data driven chips is also reduced so as the manufacturing cost.

### BACKGROUND OF THE INVENTION

1. Field of the Invention

The present disclosure relates to liquid crystal display technology, and more particularly to an array substrate and a liquid crystal panel.

2. Discussion of the Related Art

LCDs typically are characterized by attributes including thin, power-saving, and low radiation. These are reasons that the display devices adopting cold cathode fluorescent lamps (CCFL) or ionic liquid crystal technologies have been replaced.

FPR 3D (Film-type Patterned Retarder 3 Dimensions) panel is characterized by a plurality of advantages, such as low color loss, wide viewing angle, and less flash, and thus is the current trend of 3D display panel. Generally, a polarizer is added on the display panel to divide one image signal to a left eye image and a right eye image. The divided image are then integrated by viewers' brain to obtain a 3D image.

Pixels arranged in two adjacent rows respectively corresponds to the left eye and the right eye so as to generate the signals for left eye image and the right eye image. In the 3D display mode, as the viewing angle is large, the cross talk may occur, such as the right eye image is also observed by the left eye. In order to reduce the cross talk effect, as shown in FIG. 1, a black matrix (BM) arranged between the pixels two adjacent rows is adopted. That is, the BM area 103 is increased between a left eye pixel 101 and a right eye pixel 102. However, the BM area 103 cannot be displayed when in the 2D display mode and thus the aperture rate is greatly reduced.

Currently, the solution “1 G2D” is adopted to overcome the above problem. Referring to FIGS. 2 and 3, one pixel is divided into a first pixel area 201 and a second pixel area 202. The first pixel area 201 is driven by a data line (Data_N1), and the second pixel area 202 is driven by the data line (Data_N2). In the 2D display mode, the two data lines (Data_N1, Data_N2) input corresponding data signals such that the first pixel area 201 and the second pixel area 202 can display normally, and thus the aperture rate is enhanced. In the 3D display mode, the data line (Data_N2) controls the first pixel area 201 to display a black image to block the cross talk signals.

However, with the above configuration, each pixel has to be driven by two data lines. The increase of the data lines not only increases the number of the data driven chips but also reduces the aperture rate.

### SUMMARY

The object of the invention is to provide an array substrate and a liquid crystal display not only to increase the aperture rate in the 2D display mode, but also decrease the cross talk effect in the 3D display mode. In addition, the number of the data driven chips is reduced.

In one aspect, an array substrate includes: a plurality of first scanning lines, a plurality of second scanning lines, a plurality of data lines, common electrodes, and a plurality of pixel cells arranged in a matrix comprising rows and columns, each of the pixels cell corresponds to one first scanning line, one second scanning line, and one data line; each of the pixel cells includes a first pixel electrode, a second pixel electrode, a first switch, a second switch, and a third switch, the first pixel electrode and the second pixel electrode are arranged on a row-by-row basis, each of the switch includes a control end, an input end, and an output end, the control end of the first switch and the control end of the second switch connect to the first scanning line, the input end of the first switch and the input end of the second switch connect to the data line, the output end of the first switch connects to the first pixel electrode, and the output end of the second switch connects to the second pixel electrode, the control end of the third switch connects to the second scanning line, the input end of the third switch connects to one of the first or second pixel electrode, and the output end of the third switch connects to the common electrodes; all of the second scanning lines are electrically connected in a periphery of the array substrate, the first scanning line, the second scanning line, the first switch, the second switch, and the third switch are arranged between the first pixel electrode and the second pixel electrode; and wherein in the 2D display mode, the second scanning line turns off the third switch, scanning signals are input to the first scanning line to turn on the first switch and the second switch, the data line inputs the data signals to the first pixel electrode and the second pixel electrode respectively via the first switch and the second switch such that the first pixel electrode and the second pixel electrode display corresponding 2D image, and when in the 3D display mode, the second scanning line turns on the third switch, the scanning signals are input to the first scanning line to turn on the first switch and the second switch, the data line inputs the data signals to the first pixel electrode and the second pixel electrode respectively via the first switch and the second switch such that the first pixel electrode or the second pixel electrode connected to the input end of the third switch displays a black image, and the other pixel electrode displays the corresponding 3D image.

Wherein the first switch, the second switch, and the third switch are respectively a first thin film transistor (TFT), a second TFT, and a third TFT, the control end of the switch corresponds to a gate of the TFT, the input end of the switch corresponds to a source of the TFT, and the output end of the switch correspond to a drain of the TFT.

In another aspect, an array substrate includes: a plurality of first scanning lines, a plurality of second scanning lines, a plurality of data lines, common electrodes, and a plurality of pixel cells arranged in a matrix comprising rows and columns, each of the pixels cell corresponds to one first scanning line, one second scanning line, and one data line; each of the pixel cells includes a first pixel electrode, a second pixel electrode, a first switch, a second switch, and a third switch, the first pixel electrode and the second pixel electrode are arranged on a row-by-row basis, each of the switch includes a control end, an input end, and an output end, the control end of the first switch and the control end of the second switch connect to the first scanning line, the input end of the first switch and the input end of the second switch connect to the data line, the output end of the first switch connects to the first pixel electrode, and the output end of the second switch connects to the second pixel electrode, the control end of the third switch connects to the second scanning line, the input end of the third switch connects to one of the first or second pixel electrode, and the output end of the third switch connects to the common electrodes; and wherein in the 2D display mode, the second scanning line turns off the third switch, scanning signals are input to the first scanning line to turn on die first switch and die second switch, the data line inputs the data signals to the first pixel electrode and the second pixel electrode respectively via the first switch and the second switch such that the first pixel electrode and the second pixel electrode display corresponding 2D image, and when in the 3D display mode, the second scanning line turns on the third switch, the scanning signals are input to the first scanning line to turn on the first switch and the second switch, the data line inputs the data signals to the first pixel electrode and the second pixel electrode respectively via the first switch and the second switch such that the first pixel electrode or the second pixel electrode connected to the input end of the third switch displays a black image, and the other pixel electrode displays the corresponding 3D image.

Wherein all of the second scanning lines are electrically connected in a periphery of the array substrate.

Wherein the first scanning line, the second scanning line, the first switch, the second switch, and the third switch are arranged between the first pixel electrode and the second pixel electrode.

Wherein the first switch, the second switch, and the third switch are respectively a first thin film transistor (TFT), a second TFT, and a third TFT, the control end of the switch corresponds to a gate of the TFT, the input end of the switch corresponds to a source of the TFT and the output end of the switch correspond to a drain of the TFT.

In another aspect, a liquid crystal panel includes: an array substrate, a color filtering substrate, and a liquid crystal layer between the array substrate and the color filtering substrate. The array substrate includes: a plurality of first scanning lines, a plurality of second scanning lines, a plurality of data lines, common electrodes, and a plurality of pixel cells arranged in a matrix comprising rows and columns, each of the pixels cell corresponds to one first scanning line, one second scanning line, and one data line; each of the pixel cells includes a first pixel electrode, a second pixel electrode, a first switch, a second switch, and a third switch, the first pixel electrode and the second pixel electrode are arranged on a row-by-row basis, each of the switch includes a control end, an input end, and an output end, the control end of the first switch and the control end of the second switch connect to the first scanning line, the input end of the first switch and the input end of the second switch connect to the data line, the output end of the first switch connects to the first pixel electrode, and the output end of the second switch connects to the second pixel electrode, the control end of the third switch connects to the second scanning line, the input end of the third switch connects to one of the first or second pixel electrode, and the output end of the third switch connects to the common electrodes; and wherein in the 2D display mode, the second scanning line turns off the third switch, scanning signals are input to the first scanning line to turn on the first switch and the second switch, the data line inputs the data signals to the first pixel electrode and the second pixel electrode respectively via the first switch and the second switch such that the first pixel electrode and the second pixel electrode display corresponding 2D image, and when in the 3D display mode, the second scanning line turns on the third switch, the scanning signals are input to the first scanning line to turn on the first switch and the second switch, the data line inputs the data signals to the first pixel electrode and the second pixel electrode respectively via the first switch and the second switch such that the first pixel electrode or the second pixel electrode connected to the input end of the third switch display a black image, and the other pixel electrode displays the corresponding 3D image.

Wherein all of the second scanning lines are electrically connected in a periphery of the array substrate.

Wherein the first scanning line, the second scanning line, the first switch, the second switch, and the third switch are arranged between the first pixel electrode and the second pixel electrode.

Wherein the first switch, the second switch, and the third switch are respectively a first thin film transistor (TFT), a second TFT, and a third TFT the control end of the switch corresponds to a gate of the TFT, the input end of the switch corresponds to a source of the TFT, and the output end of the switch correspond to a drain of the TFT.

### BRIEF DESCRIPTION OF THE DRAWINGS

FIG. 1 is a schematic view of a conventional array substrate.

FIG. 2 is a schematic view of another conventional array substrate.

FIG. 3 is an equivalent-circuit diagram of the pixel cell of FIG. 2.

FIG. 4 is a schematic view of one array substrate in accordance with one embodiment.

FIG. 5 is an equivalent-circuit diagram of the pixel cell of FIG. 4.

FIG. 6 is a schematic view showing the display effect of the pixel cell of FIG. 4 in 3D display mode.

FIG. 7 is a side view of the liquid crystal panel in accordance with one embodiment.

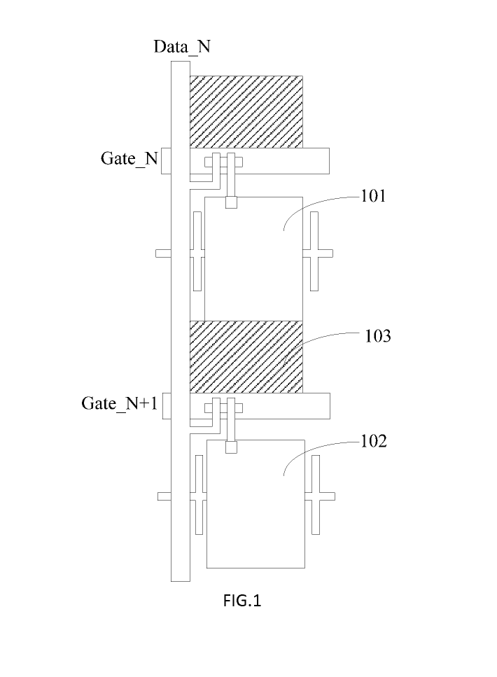

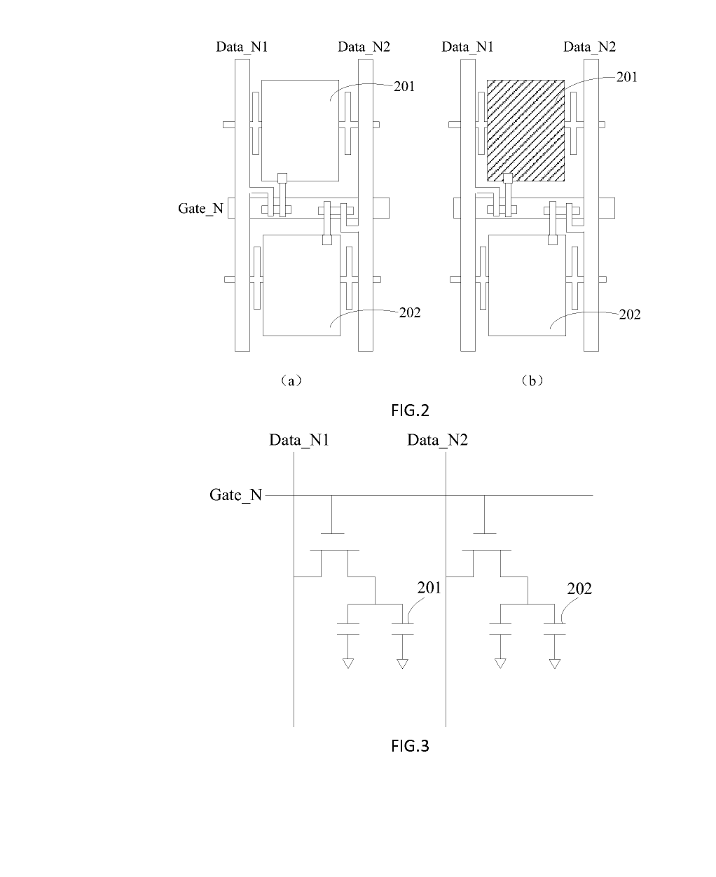

### DETAILED DESCRIPTION OF THE EMBODIMENTS

Embodiments of the invention will now be described more fully hereinafter with reference to the accompanying drawings, in which embodiments of the invention are shown.

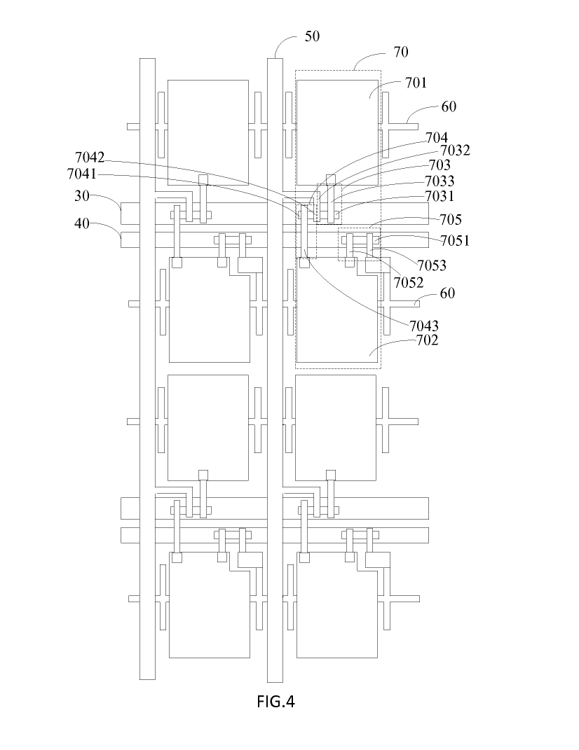

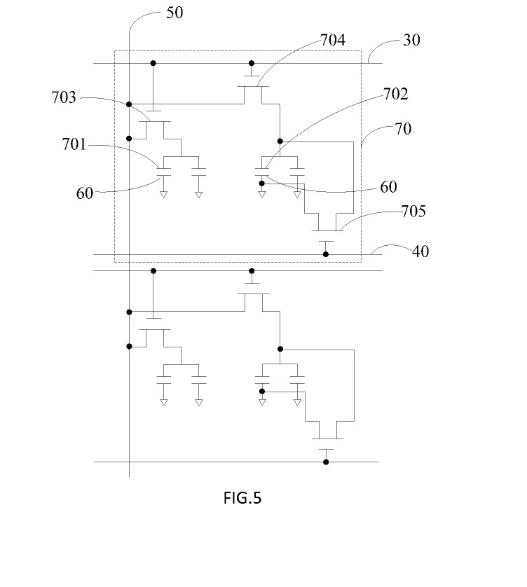

Referring to FIGS. 4 and 5, in one embodiment, the array substrate includes a plurality of first scanning lines 30, a plurality of second scanning lines 40, a plurality of data lines 50, common electrodes 60, and a plurality of pixel cell 70.

Each pixel cell 70 is driven by one first scanning line 30, one second scanning line 40, and one data line 50. The pixel cell 70 includes a first pixel electrode 701, a second pixel electrode 702, a first switch 703, a second switch 704, and a third switch 705. The first pixel electrode 701 and the second pixel electrode 702 are arranged on a row-by-row basis. That is, the first pixel electrode 701 of the pixel cell 70 is adjacent to the second pixel electrode 702 of the previous pixel cell 70, and the second pixel electrode 702 of the pixel cell 70 is adjacent to the first pixel electrode 701 of the next pixel cell 70.

Each of the first switch 703, the second switch 704, and the third switch 705 includes a control end, an input end, and an output end. The control end 7031 of the first switch 703 and the control end 7041 of the second switch 704 connect to the first scanning line 30 so as to turn on the first switch 703 and the second switch 704 by the first scanning line 30. The input end 7032 of the first switch 703 and the input end 7042 of the second switch 704 connect to the data line 50 so as to obtain data signals from the data line 50. The output end 7033 of the first switch 703 connects to the first pixel electrode 701, and the output end 7043 of the second switch 704 connects to the second pixel electrode 702. The control end 7051 of the third switch 705 connects to the second scanning line 40 so as to turn on or off the third switch 705 by the second scanning line 40. The input end 7052 of the third switch 705 connects to the second pixel electrode 702. The output end 7053 of the third switch 705 connects to the common electrodes 60.

Furthermore, all of the second scanning line 40 are electrically connected in a periphery of the array substrate, which corresponds to the periphery of the display area. The first scanning line 30, the second scanning line 40, the first switch 703, the second switch 704, and the third switch 705 are arranged between the first pixel electrode 701 and the second pixel electrode 702.

Specifically, in the 2D display mode, low level signals, which are about −6V, are input to all of the second scanning lines 40. As such, the third switch 705 is turn off by the second scanning line 40, and the second pixel electrode 702 and the common electrodes 60 are disconnected. The scanning signals are input to the first scanning line 30 on the row-by-row basis to turn on the first switch 703 and the second switch 704. The data line 50 inputs the data signals for displaying the 2D image to the first pixel electrode 701 and the second pixel electrode 702 respectively via the first switch 703 and the second switch 704. In this way, the first pixel electrode 701 and the second pixel electrode 702 are driven to display the corresponding 2D image. Thus, all of the pixel cells 70 are capable of displaying corresponding 2D image and the aperture rate in the 2D display mode is enhanced.

In the 3D display mode, the pixel cells 70 in two adjacent rows respectively corresponds to the left eye image and the right eye image. The left eye image and the right eye image are then integrated by viewers' brain to show the three-dimensional effect.

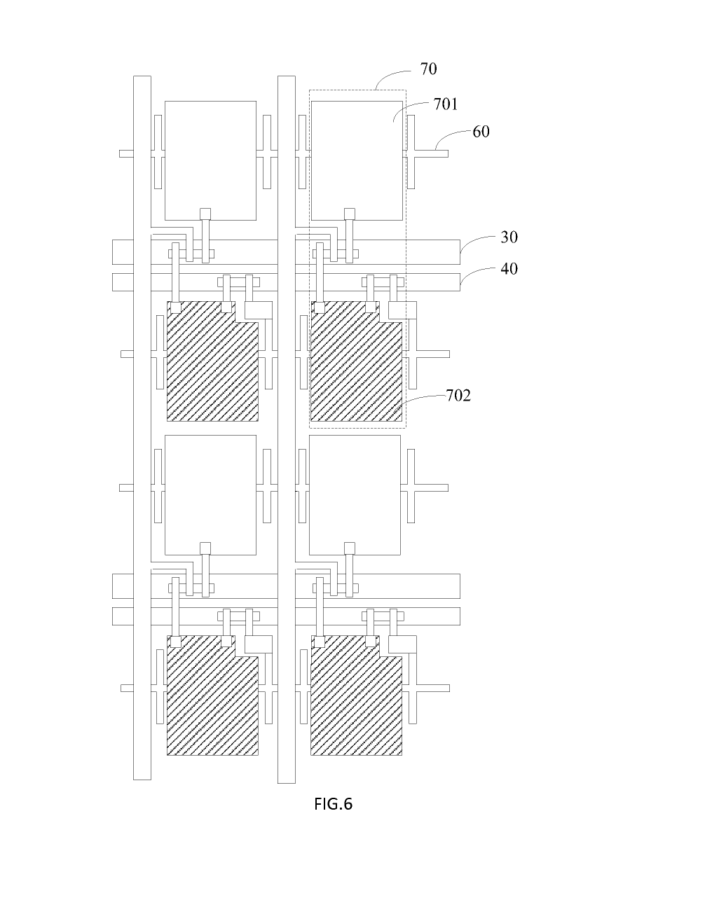

High level signals, which are in the range of 27V to 33V, are input to all of the second scanning lines 40. For example, the high level signals of 29V is input to all of the second scanning line 40 to turn on the third switch 705 such that the second pixel electrode 702 and the common electrodes 60 are turn on. The scanning signals are input to the first scanning line 30 on the row-by-row basis to turn on the first switch 703 and the second switch 704. The data line 50 inputs the data signals for displaying the 3D image to the first pixel electrode 701 and the second pixel electrode 702 respectively via the first switch 703 and the second switch 704. However, as the third switch 705 is turn on, the second pixel electrode 702 and the common electrodes are connected. As such, the voltage level of the second pixel electrode 702 and the common electrodes 60 are the same. That is, the voltage difference between the second pixel electrode 702 and the common electrodes 60 is zero. It is known that the liquid crystal panel is unable to display normally when the voltage difference between the pixel electrode of the array substrate and the common electrode of the color filtering substrate is zero, which results in a displayed black image. The voltage difference between the second pixel electrode 702 and the common electrodes 60 is zero results in the voltage difference between the second pixel electrode 702 and the common electrode of the color filtering substrate is also zero. As such, referring to FIG. 6, the second pixel electrode 702 displays the black image, and the first pixel electrode 701 displays the corresponding 3D image when the data line 50 inputs the data signals to the first pixel electrode 701. For one of the two pixel cell 70 in two adjacent rows, the first pixel electrode 701 displays the 3D image corresponding to the left eye image, and the second pixel electrode 702 displays the black image as the second pixel electrode 702 and the common electrodes 60 are electrically connected. The first pixel electrode 701 of the other pixel cell 70 displays the 3D image corresponding to the right eye image, and the second pixel electrode 702 displays the black image. As such, the black area is between the first pixel electrodes 701 of the pixel cells 70 arranged in two adjacent rows, which are respectively configured to display the left eye image and the right eye image. The second pixel electrode 702 displaying the black image works equivalent to the black matrix for preventing the left eye image from entering viewers' right eye and for preventing the right eye image from entering viewers' left eye. Thus, the cross talk is reduced.

In one embodiment, the first switch 703, the second switch 704, and the third switch 705 are thin film transistors (TFTs). Specifically, the first switch 703, the second switch 704, and the third switch 705 are respectively the first TFT, the second TFT, and the third TFT. The control end of the switch corresponds to the gate of the TFT, the input end of the switch corresponds to the source of the TFT, and the output end of the switch correspond to the drain of the TFT. In other embodiments, the first switch 703, the second switch 704, and the third switch 705 may be, but not limited to, triode or Darlington transistors.

With the above configuration, in the 2D display mode, the second scanning line 40 turns off the third switch 705 such that the second pixel electrode 702 and the common electrodes 60 are disconnected. Under the circumstance, when the data line 50 inputs the data signals for displaying the 2D image, the first pixel electrode 701 and the second pixel electrode 702 display the corresponding 2D image normally. Thus, the aperture rate in the 2D display mode is enhanced.

In the 3D display mode, the second scanning line 40 turns on the third switch 705 such that the second pixel electrode 702 and the common electrodes 60 are connected. Under the circumstance, when the data line 50 inputs the data signals for displaying the 3D image, the first pixel electrode 701 displays the corresponding 3D image normally, and the second pixel electrode 702 displays the black image. As such, the black area is between the first pixel electrodes 701 of the pixel cells 70 arranged in two adjacent rows, which are respectively configured to display the left eye image and the right eye image. The black area works equivalent to the black matrix and can reduce the cross talk.

In addition, as each of the pixel cell 70 is driven by one first scanning line 30, one second scanning line 40 and one data line 50. The number of data lines and the data driven chips are reduced, and the number of the second scanning line 40 is increased. However, the manufacturing cost is reduced for the reason that the cost of the scanning driven chips is lower than that of the data driven chips. In addition, the driving circuit of the scanning line is simpler than that of the data line, and the length of the scanning line is longer than that of the data line. Thus, the above configuration may enhance the aperture rate.

In other embodiments, the input end of the third switch connects to the first pixel electrode. As such, in the 3D display mode, the second scanning line turns on the third switch, and the first pixel electrode and the common electrode are connected. The voltage difference between the first pixel electrode and the common electrode is zero. Under the circumstance, when the data lines input the data signals for displaying the 3D image, the first pixel electrode displays the black image, and the second pixel electrode displays the 3D image normally. The first pixel electrode displaying the black image is equivalent to the black matrix. As such, the cross talk in the 3D display mode can be reduced.

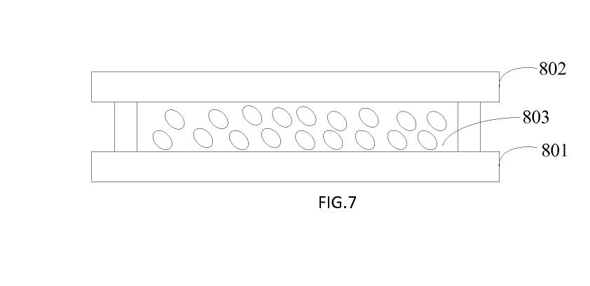

FIG. 7 is a side view of the liquid crystal panel in accordance with one embodiment. The liquid crystal panel includes the array substrate 801, a color filtering substrate 802, and a liquid crystal layer 803 between the array substrate 801 and the color filtering substrate 802. The array substrate is one of the above-mentioned array substrate.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An array substrate, comprising:
a plurality of first scanning lines, a plurality of second scanning lines, a plurality of data lines, common electrodes, and a plurality of pixel cells arranged in a matrix comprising rows and columns, each of the pixels cell corresponds to one first scanning line, one second scanning line, and one data line;
each of the pixel cells comprises a first pixel electrode, a second pixel electrode, a first switch, a second switch, and a third switch, the first pixel electrode and the second pixel electrode are arranged on a row-by-row basis, each of the switch includes a control end, an input end, and an output end, the control end of the first switch and the control end of the second switch connect to the first scanning line, the input end of the first switch and the input end of the second switch connect to the data line, the output end of the first switch connects to the first pixel electrode, and the output end of the second switch connects to the second pixel electrode, the control end of the third switch connects to the second scanning line, the input end of the third switch connects to one of the first or second pixel electrode, and the output end of the third switch connects to the common electrodes;
all of the second scanning lines are electrically connected in a periphery of the array substrate, the first scanning line, the second scanning line, the first switch, the second switch, and the third switch are arranged between the first pixel electrode and the second pixel electrode; and
wherein in the 2D display mode, the second scanning line turns off the third switch, scanning signals are input to the first scanning line to turn on the first switch and the second switch, the data line inputs the data signals to the first pixel electrode and the second pixel electrode respectively via the first switch and the second switch such that the first pixel electrode and the second pixel electrode display corresponding 2D image, and when in the 3D display mode, the second scanning line turns on the third switch, the scanning signals are input to the first scanning line to turn on the first switch and the second switch, the data line inputs the data signals to the first pixel electrode and the second pixel electrode respectively via the first switch and the second switch such that the first pixel electrode or the second pixel electrode connected to the input end of the third switch displays a black image, and the other pixel electrode displays the corresponding 3D image.

2. The array substrate as claimed in claim 1, wherein the first switch, the second switch, and the third switch are respectively a first thin film transistor (TFT), a second TFT, and a third TFT, the control end of the switch corresponds to a gate of the TFT, the input end of the switch corresponds to a source of the TFT, and the output end of the switch correspond to a drain of the TFT.

3. An array substrate, comprising:
a plurality of first scanning lines, a plurality of second scanning lines, a plurality of data lines, common electrodes, and a plurality of pixel cells arranged in a matrix comprising rows and columns, each of the pixels cell corresponds to one first scanning line, one second scanning line, and one data line;
each of the pixel cells comprises a first pixel electrode, a second pixel electrode, a first switch, a second switch, and a third switch, the first pixel electrode and the second pixel electrode are arranged on a row-by-row basis, each of the switch includes a control end, an input end, and an output end, the control end of the first switch and the control end of the second switch connect to the first scanning line, the input end of the first switch and the input end of the second switch connect to the data line, the output end of the first switch connects to the first pixel electrode, and the output end of the second switch connects to the second pixel electrode, the control end of the third switch connects to the second scanning line, the input end of the third switch connects to one of the first or second pixel electrode, and the output end of the third switch connects to the common electrodes; and
wherein in the 2D display mode, the second scanning line turns off the third switch, scanning signals are input to the first scanning line to turn on the first switch and the second switch, the data line inputs the data signals to the first pixel electrode and the second pixel electrode respectively via the first switch and the second switch such that the first pixel electrode and the second pixel electrode display corresponding 2D image, and when in the 3D display mode, the second scanning line turns on the third switch, the scanning signals are input to the first scanning line to turn on the first switch and the second switch, the data line inputs the data signals to the first pixel electrode and the second pixel electrode respectively via the first switch and the second switch such that the first pixel electrode or the second pixel electrode connected to the input end of the third switch displays a black image, and the other pixel electrode displays the corresponding 3D image.

4. The array substrate as claimed in claim 3, wherein all of the second scanning lines are electrically connected in a periphery of the array substrate.

5. The array substrate as claimed in claim 3, wherein the first scanning line, the second scanning line, the first switch, the second switch, and the third switch are arranged between the first pixel electrode and the second pixel electrode.

6. The array substrate as claimed in claim 3, wherein the first switch, the second switch, and the third switch are respectively a first thin film transistor (TFT), a second TFT, and a third TFT, the control end of the switch corresponds to a gate of the TFT, the input end of the switch corresponds to a source of the TFT, and the output end of the switch correspond to a drain of the TFT.

7. A liquid crystal panel, comprising:
an array substrate, a color filtering substrate, and a liquid crystal layer between the array substrate and the color filtering substrate, the array substrate comprises:
a plurality of first scanning lines, a plurality of second scanning lines, a plurality of data lines, common electrodes, and a plurality of pixel cells arranged in a matrix comprising rows and columns, each of the pixels cell corresponds to one first scanning line, one second scanning line, and one data line;
each of the pixel cells comprises a first pixel electrode, a second pixel electrode, a first switch, a second switch, and a third switch, the first pixel electrode and the second pixel electrode are arranged on a row-by-row basis, each of the switch includes a control end, an input end, and an output end, the control end of the first switch and the control end of the second switch connect to the first scanning line, the input end of the first switch and the input end of the second switch connect to the data line, the output end of the first switch connects to the first pixel electrode, and the output end of the second switch connects to the second pixel electrode, the control end of the third switch connects to the second scanning line, the input end of the third switch connects to one of the first or second pixel electrode, and the output end of the third switch connects to the common electrodes; and
wherein in the 2D display mode, the second scanning line turns off the third switch, scanning signals are input to the first scanning line to turn on the first switch and the second switch, the data line inputs the data signals to the first pixel electrode and the second pixel electrode respectively via the first switch and the second switch such that the first pixel electrode and the second pixel electrode display corresponding 2D image, and when in the 3D display mode, the second scanning line turns on the third switch, the scanning signals are input to the first scanning line to turn on the first switch and the second switch, the data line inputs the data signals to the first pixel electrode and the second pixel electrode respectively via the first switch and the second switch such that the first pixel electrode or the second pixel electrode connected to the input end of the third switch display a black image, and the other pixel electrode displays the corresponding 3D image.

8. The liquid crystal panel as claimed in claim 7, wherein all of the second scanning lines are electrically connected in a periphery of the array substrate.

9. The liquid crystal panel as claimed in claim 7, wherein the first scanning line, the second scanning line, the first switch, the second switch, and the third switch are arranged between the first pixel electrode and the second pixel electrode.

10. The liquid crystal panel as claimed in claim 7, wherein the first switch, the second switch, and the third switch are respectively a first thin film transistor (TFT), a second TFT, and a third TFT, the control end of the switch corresponds to a gate of the TFT the input end of the switch corresponds to a source of the TFT, and the output end of the switch correspond to a drain of the TFT.
